(19) United States
(12) Patent Application Publication
(10) Pub. No.: US 2003/0020814 A1
(43) Pub. Date: Jan. 30, 2003

(54) Image capturing apparatus

(75) Inventor: Shuji Ono, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/166,271

(22) Filed: Jun. 11, 2002

(30) Foreign Application Priority Data
Jul. 25, 2001 (JP) 2001-225212

(51) Int. Cl. H04N 5/225

(52) U.S. Cl. 348/220.1

(57) ABSTRACT

An image capturing apparatus for capturing an image of a subject includes: a capturing unit having a plurality of capturing optical systems and a plurality of capturing devices for receiving light beams from the capturing optical systems to capture images of the subject, respectively, and outputting capture signals; a capture condition acquiring unit for acquiring information indicating a capture condition determined based on a positional relationship between the subject and the image capturing apparatus; and a selection controller for controlling the capturing unit to select one of the capturing optical systems and/or one of the capturing devices in accordance with the capture condition acquired by the capture condition acquiring unit.

This patent application claims priority from a Japanese patent application No. 2001-225212 filed on Jul. 25, 2001, the contents of which are incorporated herein by reference.

### BACKGROUND OF THE INVENTION

1. Field of the Invention

The present invention relates to an image capturing apparatus for capturing an image of a subject.

2. Description of the Related Art

As an image capturing apparatus for capturing an image of a subject, a video movie camera which stores the captured image in a magnetic storage medium such as a video tape, a digital camera which converts the captured image into digital data and stores the digital data in a storage medium such as a semiconductor memory, and the like are known.

According to the conventional image capturing apparatuses, however, applications in which the image capturing can be performed are limited by the performance of a capturing system formed by a capturing optical system, a capturing device and the like. Thus, it is difficult to deal with various applications by a single image capturing apparatus.

### SUMMARY OF THE INVENTION

Therefore, it is an object of the present invention to provide an image capturing apparatus, which is capable of overcoming the above drawbacks accompanying the conventional art. The above and other objects can be achieved by combinations described in the independent claims. The dependent claims define further advantageous and exemplary combinations of the present invention.

According to an aspect of the present invention, an image capturing apparatus for capturing an image of a subject, comprises: a capturing unit including a plurality of capturing optical systems and a plurality of capturing devices operable to receive light beams from said plurality of capturing optical systems to capture images of said subject, respectively, and output capture signals; a capture condition acquiring unit operable to acquire information indicating a capture condition determined based on a positional relationship between said subject and said image capturing apparatus; and a selection controller operable to control said capturing unit to select one of said plurality of capturing optical systems and/or one of said plurality of capturing devices in accordance with said capture condition acquired by said capture condition acquiring unit.

The plurality of capturing optical systems may include a first capturing optical system having a shorter focal length and a second capturing optical system having a longer focal length; the capture condition acquiring unit may include a distance measuring unit operable to acquire information indicating a distance between said subject and said image capturing apparatus, as said information indicating said capture condition; and the selection controller may control said capturing unit to select said first capturing optical system when said distance between said subject and said image capturing apparatus is shorter than a predetermined distance or said second capturing optical system when said distance between said subject and said image capturing apparatus is longer than said predetermined distance.

The plurality of capturing optical systems may include a first capturing optical system having a larger wavelength transmittance in a natural light region and a second capturing optical system having a smaller wavelength transmittance in said natural light region; the capture condition acquiring unit may include a luminance measuring unit operable to acquire information indicating an intensity of light incident on said capturing devices determined depending on brightness of illumination for illuminating said subject, as said information indicating said capture condition; and the selection controller may control said capturing unit to select said first capturing optical system when said intensity of said incident light is weaker than a predetermined intensity or said second capturing optical system when said intensity of said incident light is stronger than said predetermined intensity.

The plurality of capturing devices may include a first capturing device having a higher light sensitivity in a natural light region and a second capturing device having a lower light sensitivity in said natural light region; the capture condition acquiring unit may include a luminance measuring unit operable to acquire information indicating an intensity of light incident on said capturing devices determined depending on brightness of illumination for illuminating said subject, as said information indicating said capture condition; and the selection controller may control said capturing unit to select said first capturing device when said intensity of said incident light is weaker than a predetermined intensity or said second capturing device when said intensity of said incident light is stronger than said predetermined intensity.

In this case, the plurality of optical systems may include a first capturing optical system having a larger wavelength transmittance in said natural light region and a second capturing optical system having a smaller wavelength transmittance in said natural light region, and the selection controller may control said capturing unit to select said first capturing optical system when said intensity of said incident light is weaker than the predetermined intensity or said second capturing optical system when said intensity of said incident light is stronger than said predetermined intensity.

The plurality of optical systems may include a first capturing optical system having a smaller wavelength transmittance in an infrared light region and a second capturing optical system having a larger wavelength transmittance in said infrared light region; the capture condition acquiring unit may include a luminance measuring unit operable to acquire information indicating an intensity of light incident on said capturing devices determined depending on brightness of illumination for illuminating said subject, as said information indicating said capture condition; and the selection controller may control said capturing unit to select said first capturing optical system when said intensity of said incident light is stronger than a predetermined intensity or said second capturing optical system when said intensity of said incident light is weaker than said predetermined intensity.

The plurality of capturing devices may include a first capturing device having a lower light sensitivity in an infrared light region and a second capturing device having a higher light sensitivity in said infrared light region; the capture condition acquiring unit may include a luminance measuring unit operable to acquire information indicating an intensity of light incident on said capturing devices determined depending on brightness of illumination for illuminating said subject, as said information indicating said capture condition; and the selection controller may control said capturing unit to select said first capturing device when said intensity of said incident light is stronger than a predetermined intensity or said second capturing device when said intensity of said incident light is weaker than said predetermined intensity.

In this case, the plurality of optical systems may include a first capturing optical system having a smaller wavelength transmittance in said infrared light region and a second capturing optical system having a larger wavelength transmittance in said infrared light region, and the selection controller may control said capturing unit to select said first capturing optical system when said intensity of said incident light is stronger than the predetermined intensity or said second capturing optical system when said intensity of said incident light is weaker than said predetermined intensity.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an appearance of a digital camera as an example of an image capturing apparatus according to the present invention.

FIG. 2 is a block diagram of the digital camera shown in FIG. 1.

FIG. 3 shows exemplary combinations of types of capturing characteristics of two capturing devices in a capturing device unit.

FIG. 4 shows exemplary combinations of types of two capturing optical systems in a capturing optical unit.

FIG. 5 shows exemplary combinations of focal length regions of two zoom lenses.

FIG. 6 shows details of an image capturing unit of the digital camera according to the first embodiment of the present invention.

FIG. 7 shows the details of the image capturing unit of the digital camera according to the second embodiment of the present invention.

FIG. 8 shows the details of the image capturing unit of the digital camera according to the third embodiment of the present invention.

FIG. 9 shows the details of the image capturing unit of the digital camera according to the fourth embodiment of the present invention.

FIG. 10 shows the details of the image capturing unit of the digital camera according to the fifth embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

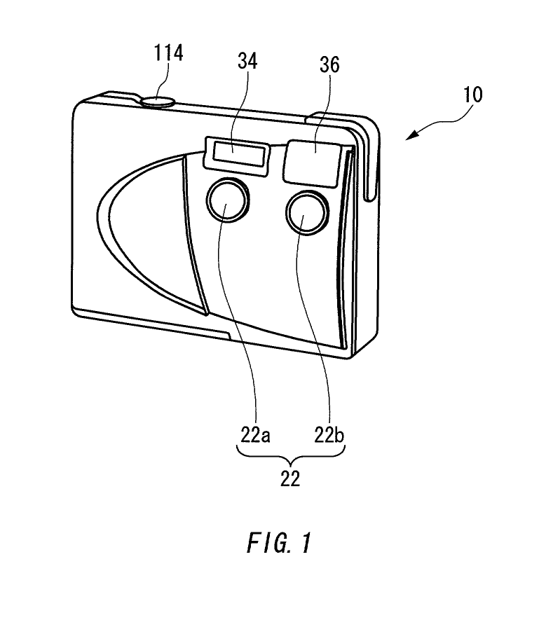

FIG. 1 shows an appearance of a digital camera 10 as an example of an image capturing apparatus of the present invention. The digital camera 10 contains a digital still camera, a digital video camera capable of capturing a still image, and the like. The digital camera 10 has two capturing lenses 22a, 22b (referred to as a capturing lens 22 as a whole), a finder unit 34 and an electronic flash 36 that are provided on a face of a body of the digital camera 10 which faces a subject for which an image to be captured. The digital camera 10 further has a release switch 114 on a top face of the body.

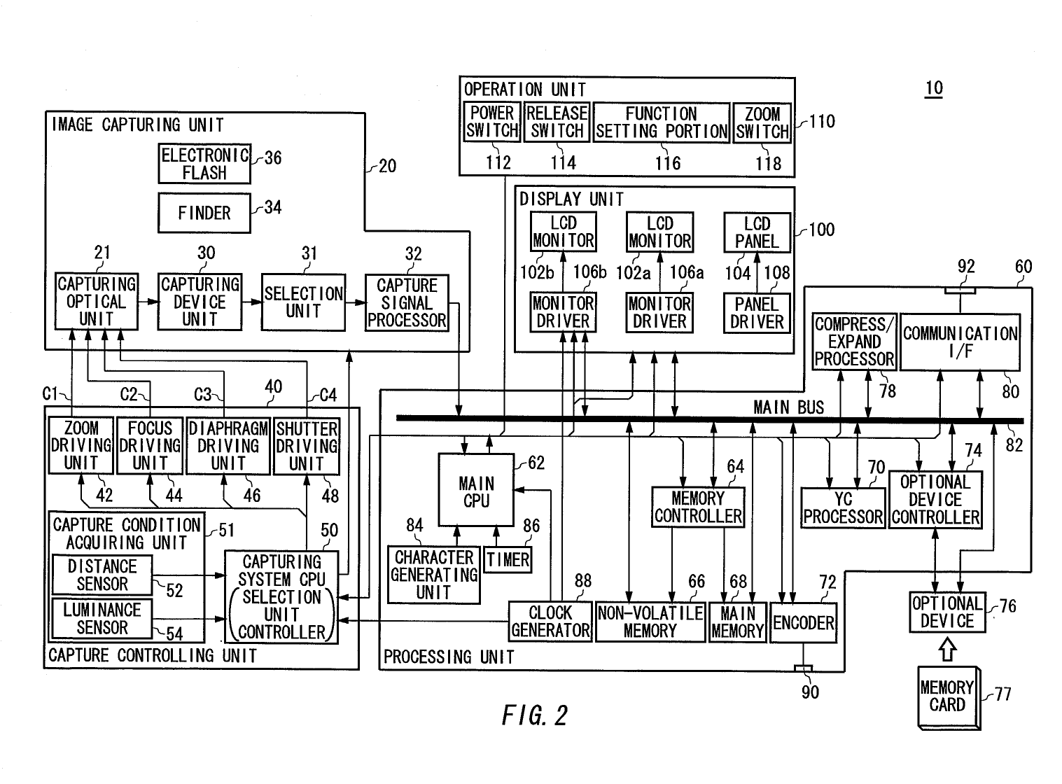

FIG. 2 is a block diagram of the digital camera 10. The digital camera 10 includes an image capturing unit 20, a capture controlling unit 40, a processing unit 60, a display unit 100 as an example of an image display, and an operation unit 110.

The image capturing unit 20 has mechanical members and electric members related to image capturing and image forming. The image capturing unit 20 includes a capturing optical unit 21 having a plurality of separate capturing optical systems for taking in images of the subject, respectively, and a capturing device unit 30 having a plurality of capturing devices for receiving light from the corresponding capturing optical systems so as to capture the subject images, respectively. The capturing device is a CCD that is an example of a solid-state image sensing device, for example. In the present embodiment, the capturing optical unit 21 has two capturing optical systems, and the capturing device unit 30 has two capturing devices that correspond to the capturing devices of the capturing optical unit 21, respectively.

The image capturing unit 20 further includes: a selection unit 31 that can select one of capture signals respectively obtained by the capturing devices; a capture signal processor 32 which performs predetermined image processing for the capture signal selected by the selection unit 31 and then outputs the capture signal after being processed to the processing unit 60; a finder unit 34 and an electronic flash 36.

The capture controlling unit 40 includes a zoom driving unit 42, a focus driving unit 44, a diaphragm driving unit 46, a shutter driving unit 48, a capturing system CPU 50 that controls those components, and a capture condition acquiring unit 51 having a distance sensor 52 as an example of a distance measuring unit and a luminance sensor 54 as an example of a luminance measuring unit. The capturing system CPU 50 also serves as a selection controller of the present invention. The driving units such as the zoom driving unit 42 have associated driving means such as stepping motors, respectively.

When the release switch (shutter switch) 114 described later has been pressed, the distance sensor 52 measures a distance between the subject and the digital camera 10 so as to obtain distance data as an example of information indicating a capturing condition (hereinafter, referred to as measured distance data). At that time, the luminance sensor 54 measures the intensity of light incident on the CCD, that is determined depending on the brightness of illumination for illuminating the subject, by measuring the luminance of the subject, so as to obtain data of the subject luminance (hereinafter, referred to as measured luminance data) as an example of the information indicating the capture condition. The capturing condition acquiring unit 51 sends the measured distance data and measured luminance data thus acquired to the capturing system CPU 50. The capturing system CPU 50 controls the zoom driving unit 42 with a control signal Cl to adjust the magnification obtained by zoom lenses 220a and 220b described later in accordance with capturing information such as the zoom magnification specified by the user (a person who operates the digital camera 10), and also controls the focus driving unit 44 with a control signal C2 to adjust the focus of focus lenses 222a and 222b described later. The capturing system CPU 50 may control the zoom driving unit 42 to move the respective lenses, in order to capture parallax images, for example.

The capturing system CPU 50 determines the F-number and the shutter speed based on an integrated values of the R, G and B digital signals of one image frame, that is, AE information. In accordance with the determined F number and shutter speed, the diaphragm driving unit 46 adjusts the size of an aperture of the diaphragm by a control signal C3 and the shutter driving unit 48 performs opening/closing the shutter by a control signal C4.

Moreover, the capturing system CPU 50 controls the light emission by the electronic flash 36 based on the measured luminance data and also adjusts the aperture size of the diaphragm. When the user instructs the digital camera 10 to capture an image, the capturing device unit 30 starts to be electrically charged. After the shutter period calculated from the measured luminance data has passed, the stored electric charges are output to the capture signal processor 32.

The processing unit 60 includes a main CPU 62 for controlling the whole digital camera 10, especially the processing unit 60, which also serves as a storing controller of the present invention; a memory controller 64; a YC processor 70; an optional device controller 74; a compress/expand processor 78; a communication interface (I/F) 80; and a clock generator 88 that are controlled by the main CPU 62. In the present embodiment, a memory card 77, that is an exemplary storage medium (image memory) for storing an image, is mounted as a kind of the optional device 76.

The main CPU 62 communicates with the capturing system CPU 50 by serial communication or the like. An operation clock of the main CPU 62 is supplied from the clock generator 88 that also supplies clocks having different frequencies to the capturing system CPU 50 and the display unit 100, respectively.

In addition to the main CPU 62, a character generator 84 and a timer 86 are provided in the processing unit 60. The timer 86 has the backing of a battery cell so that the timer 86 always counts the time and date. Based on the counted values, information regarding the captured date and time and other information related to the time are supplied to the main CPU 62. The character generator 84 generates character information such as the captured date, a title of the captured image or the like. The thus generated character information is appropriately combined with the captured image.

The memory controller 64 controls a non-volatile memory 66 and a main memory 68. The non-volatile memory 66 includes an EEPROM (electrically erasable and programmable ROM), a FLASH memory or the like, and stores various data to be held even when the power of the digital camera 10 is off, such as information set by the user and parameters set when the digital camera 10 was shipped. The non-volatile memory 66 may store a boot program for the main CPU 62 or a system program, if necessary. On the other hand, the main memory 68 is formed by a relatively inexpensive memory having a larger capacity, such as a DRAM, in general. The main memory 68 has a function of a frame memory for storing data output from the image capturing unit 20, a function of a system memory for loading necessary programs, and a function of a working area. The non-volatile memory 66 and the main memory 68 communicate with the respective parts in the processing unit 60 and other parts outside the processing unit 60 via a main bus 82.

The YC processor 70 subjects the digital image data to YC conversion so as to generate a luminance signal Y and color difference signals B-Y and R-Y. The luminance signal and the color difference signals are temporarily stored in the main memory 68 by the memory controller 64. The compress/expand processor 78 successively reads the luminance signal and the color-difference signals from the main memory 68 and compresses the read signals. The resultant data (hereinafter, simply referred to as “compressed data”) is stored (written) into a predetermined storage area of the memory card 77 mounted on the digital camera 10 as a kind of the optional device 76 via the optional device controller 74.

The processing unit 60 further includes an encoder 72. The encoder 72 inputs the luminance signal and the color difference signals, converts these input signals into a video signal (NTSC or PAL signal) and then outputs the video signal from a video output terminal 90. In a case of generating the video signal from the data stored in the optional device 76, the data is first supplied to the compress/expand processor 78 via the optional device controller 74, and is then subjected to a necessary expansion operation in the compress/expand processor 78. Finally, the expanded data is converted into the video signal by the encoder 72.

The optional device controller 74 performs generation of a signal or signals required by the main bus 82 and the optional device 76, logical transform, or voltage conversion in accordance with the specification of signals accepted by the optional device 76 and the bus-specification of the main bus 82. The digital camera 10 may support a device other than the memory card 77, for example, a standard I/O card conforming to PCMCIA, as the optional device 76. In this case, the optional device controller 74 maybe formed by an LSI for controlling a bus for PCMCIA.

The communication I/F 80 controls protocol conversion or the like in accordance with the communication specification supported by the digital camera 10, such as USB, RS-232C, Ethernet (registered trademark), Bluetooth, or IrDA. The communication I/F 80 includes a driver IC, if necessary, and communicates with an external apparatus including a network via a connector 92. In addition, the digital camera 10 may be configured to allow data communication with an external apparatus such as a printer, a karaoke (sing-along machine), or a game player via a special I/F, other than the above-mentioned standard specification.

The display unit 100 includes an LCD monitor 102 as an exemplary display device and an LCD panel 104 that are controlled by a monitor driver 106 and a panel driver 108, respectively. The LCD monitor 102, that has a size of about 2 inches, for example, is provided on the back face of the digital camera 10, and displays a current operation mode such as a capture mode or a playback mode, the magnification of the image capturing or the playback, the residual amount of the battery cell, the date and time, a screen for setting modes, an image of the subject, or the like. The LCD panel 104 is a small monochrome LCD, for example, and is provided on the top face of the digital camera 10. The LCD panel 104 simply displays information such as the image quality (FINE/NORMAL/BASIC, for example), ON/OFF of the electronic flash, the number of images normally capturable, the number of pixels, and the battery capacity or the like.

The operation unit 110 includes mechanisms and electric members required for the user to set or instruct the operation and the operation mode of the digital camera 10 to the digital camera 10. A power switch 112 determines whether or not the power of the digital camera 10 is turned on/off.

The release switch 114 has a two-step structure allowing half-pressing and complete-pressing of it. The main CPU 62 determines the contact with the release switch 114 by a person operating the digital camera 10 or the half-pressing of the release switch 114 (half-pressing of the shutter) as an operation instructing preprocessing of the image capturing. Also, the main CPU 62 determines the complete-pressing of the release switch 114 by the operator (complete-pressing of the shutter) as an executive operation of the image capturing. For example, when the release switch 114 is half-pressed, AF and AE are locked. Then, the release switch 114 is completely pressed, a shot image is taken into the digital camera 10 and is recorded in the main memory 68 and/or the optional device 76 after necessary signal processing and data compression and the like are performed. The operation unit 110 may receive settings set by a switch other than the above-mentioned switches, such as a rotary mode dial or a cross key. These switches as a whole are called as a function setting portion 116 in FIG. 2. The operations or functions that can be set by the operation unit 110 include “file format”, “special effect”, “print”, “determine/save”, and “change display”, for example. The zoom switch determines the zooming magnification.

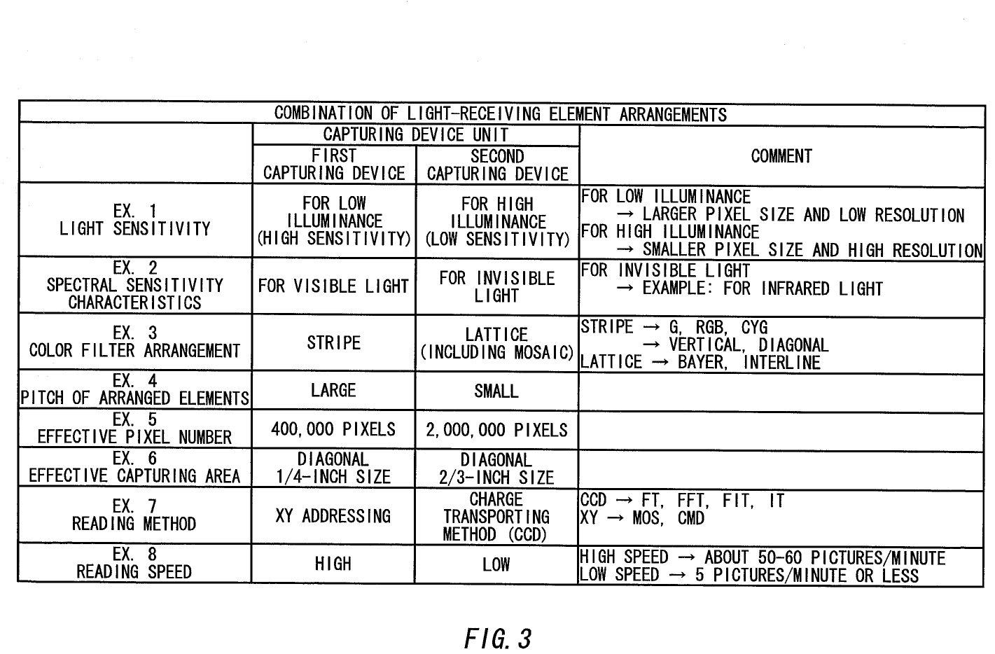

FIG. 3 shows exemplary combinations of types of capturing characteristics of two solid-state image sensing devices of the capturing device unit 30. The capturing device unit 30 can provide different types of capturing characteristics by different embodiments of arrangements of light-receiving elements forming the respective solid-stage image sensing devices (for example, different combinations of shapes and arrangement of the light-receiving elements).

For example, the capturing device 30 includes a combination of capturing devices having different light sensitivities to the light intensity input (or different dynamic ranges) from each other (Example 1) or another combination of the capturing devices having spectral sensitivities that are at least partially different from each other (Example 2).

In the combination of different light sensitivities (Example 1), for example, the first capturing device has a large pixel size (light-receiving area) in each light-receiving element and is a device suitable for capturing with light illuminance which has a low resolution and a higher light sensitivity in a natural light region. In this case, for example, the second capturing device has a small pixel size and is a device suitable for capturing with relatively high illuminance that has a high resolution and a lower light sensitivity in the natural light region.

In the combination of different spectral sensitivity characteristics (Example 2), for example, the first capturing device may have higher spectral sensitivity than that of the second capturing device in a visible light region and lower spectral sensitivity than that of the second capturing device in an invisible light region (such as an infrared light region). That is, the first capturing device may be suitable for capturing with visible light, while the second capturing device is suitable for capturing with invisible light. Please note that, in a case where the first capturing device is arranged to be suitable for capturing with visible light, the first capturing optical system preferably includes an infrared light (IR) cut filter. On the other hand, in a case where the second capturing device is arranged to be suitable for capturing with infrared light that is an example of invisible light, it is preferable that the second capturing optical system includes no infrared light (IR) cut filter.

In a case where the respective capturing devices are for color image capturing, the respective color separation filters may have different arrangements (Example 3). The arrangements of color separation filters are classified into primary filter arrangements using filters of three primary colors, G (green), R (red) and B (blue) only, that put priority on color tone, and complementary filter arrangements each using filters of complementary colors such as Cy (cyan), Mg (magenta) and Ye (yellow), that put priority on resolution. Moreover, the primary filter arrangements are further classified into a stripe arrangement and a lattice arrangement. Also, the complementary filter arrangements are further classified into a color difference-sequential arrangement and an interleave arrangement. For example, the first and second capturing devices may be arranged in such a manner that the first capturing device includes the stripe arrangement of color separation filters while the second capturing device includes the lattice arrangement (containing a mosaic arrangement).

In a case of the stripe arrangement, a G stripe arrangement, an RGB stripe arrangement and a CYG stripe arrangement are known, for example. In the G stripe arrangement, G is arranged for every other pixel in a horizontal direction and R and B are arranged to form a lattice for remaining pixels. In the RGB stripe arrangement, R, G and B are alternately arranged in the horizontal direction. In the CYG stripe arrangement, G and two complementary colors Cy and Ye are alternately arranged. The direction of the stripe may be vertical or diagonal. Moreover, as the lattice arrangement, a Bayer arrangement in which a color for the luminance signal that requires a high resolution (for example, G) is arranged to form a lattice and two colors that do not require high resolution are arranged for the remaining pixels, and an interline arrangement are known.

Moreover, the capturing device unit 30 may have a combination of capturing devices having different arrangement pitches of the light-receiving elements (Example 4), a combination of capturing devices having different numbers of effective pixels that contribute the capturing by the light-receiving elements (effective capturing pixel numbers) (Example 5), or a combination of capturing devices having entire effective capturing areas different from each other (Example 6). For example, the first capturing device can be a ¼-inch (diagonal size; the same in the following description) device that has 400,000 pixels arranged at a larger pitch to realize a larger light-receiving area of the light-receiving element, while the second capturing device can be a ⅔-inch device that 2,000,000 pixels arranged at a smaller pitch to realize a smaller light-receiving area of the light-receiving element.

The capturing device unit 30 may provide different types of capturing characteristics by capturing devices to which different types of reading methods (scanning methods) are applied in order to read the stored electric charges (Example 7). For example, the first capturing device may be an XY addressing type device, while the second capturing device may be a CCD. Alternatively, both the first and second capturing devices may be devices of the same reading methods. The XY addressing type includes a MOS (including C-MOS) device, a CMD (Charge Modulation Device) that is an example of an amplifying image sensing device, or the like. On the other hand, the CCD includes an FT (Frame Transfer) technique, an FFT (Full Frame Transfer) technique, an FIT (Frame Interline Transfer) technique, an IT (Interline Transfer) technique or an all-pixel reading IT technique.

In addition, the capturing device unit 30 includes a combination of capturing devices from which the stored electric charges are read out with different reading speed (scanning speed) (Example 8). For example, the first capturing device can be a device suitable for reading with relatively high speed (for example, about 50-60 images/minute), while the second capturing device can be a device suitable for reading with relatively low speed reading (for example, 5 images/minute or less).

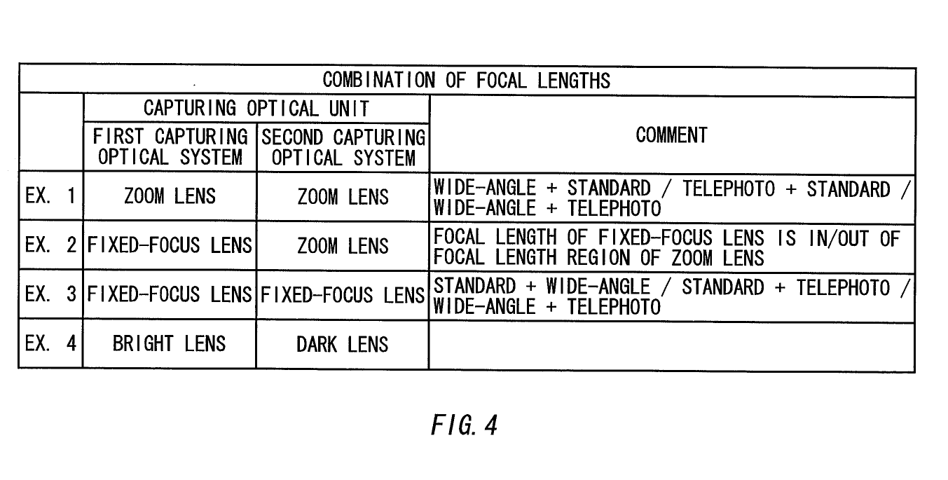

FIG. 4 shows exemplary combinations of types of two capturing optical systems in the capturing optical unit 21. The capturing optical unit 21 may include a combination of optical systems having different focal distances as different types of optical systems. For example, the capturing optical unit 21 includes a combination of two zoom lenses having different focal length ranges (Example 1), a combination of the zoom lens and a fixed-focus lens (Example 2), or a combination of two fixed-focus (single focus) lenses having different focal lengths (Example 3).

The capturing optical unit 21 may include a combination of optical systems having different brightness as the different types of the optical systems (Example 4). For example, the first optical system 21a can be a bright lens having a large wavelength transmittance in the natural light region while the second optical system 21b can be a dark lens having a small wavelength transmittance in the natural light region. The bright lens and the dark lens are, for example, a lens having a small open F number and a lens having a large open F number, respectively.

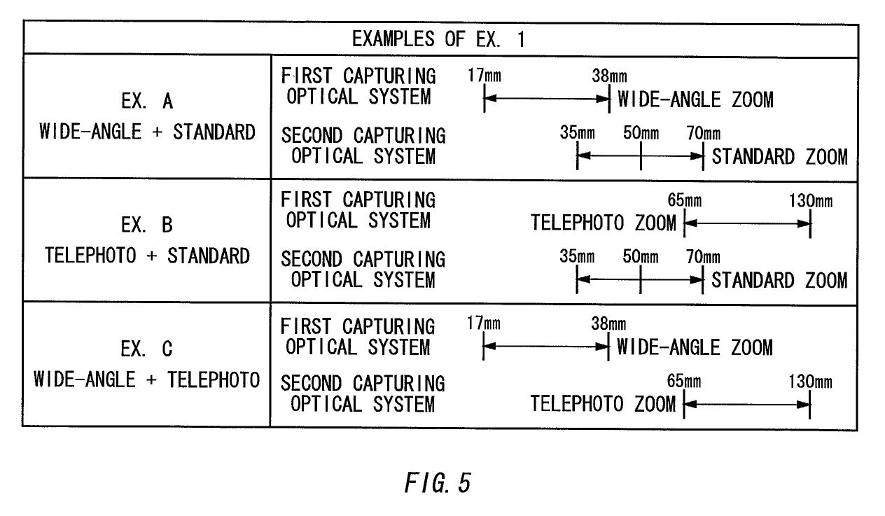

FIG. 5 shows exemplary combinations of focal length regions of two zoom lenses in a case where the capturing optical unit 21 adopts Example 1 shown in FIG. 4. For example, the capturing optical unit 21 includes a combination of a wide-angle zoom lens having a focal length of 17 mm to 38 mm and a standard zoom lens having a focal length of 35 mm to 70 mm (Example A), a combination of a telephoto zoom lens having a focal length of 65 mm to 130 mm and the standard zoom having the focal length of 35 mm to 70 mm (Example B) or a combination of the wide-angle zoom lens having the focal length of 17 mm to 38 mm and the telephoto zoom lens having the focal length of 65 mm to 130 mm (Example C).

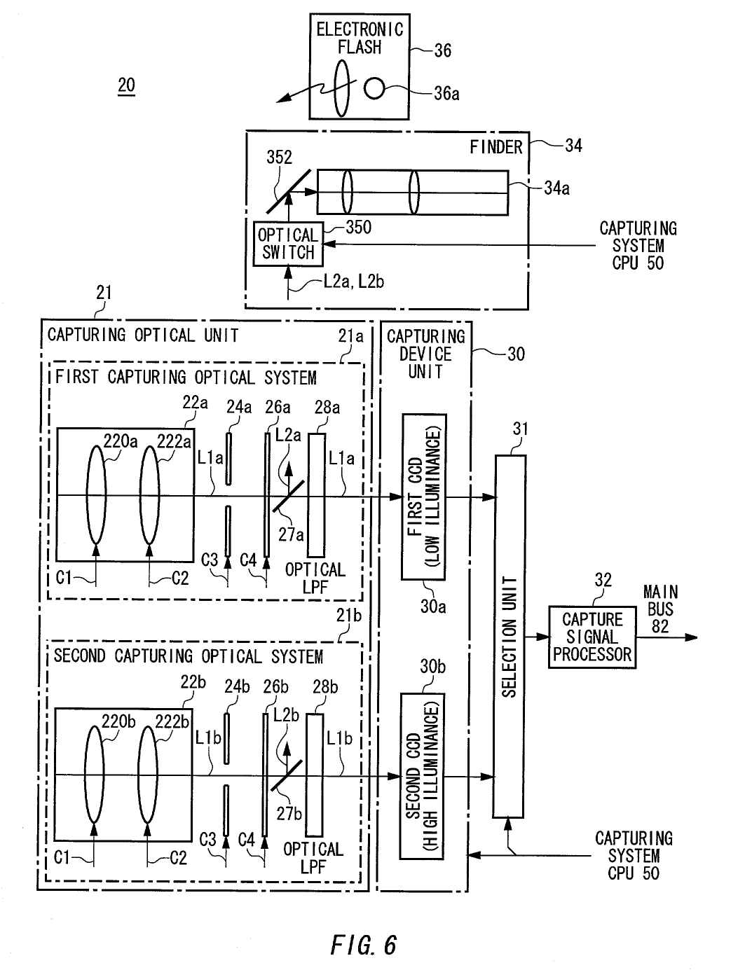

FIG. 6 shows details of the image capturing unit 20 of the digital camera 10 according to the first embodiment of the present invention. The capturing optical unit 21 includes the first capturing optical system 21a and the second capturing optical system 21b. The capturing device unit 30 includes the first CCD 30a which receives light L1a from the first capturing optical system 21a and the second CCD 30b which receives light L1b from the second capturing optical system 21b.

In this embodiment, the first CCD 30a and the second CCD 30b provide different types of capturing characteristics from each other. For example, the first CCD 30a and the second CCD 30b are the same in that they are formed by CCDs (charge transferring type image sensing devices) for color image capturing having color separation filters. However, the first and second CCDs 30a and 30b are different from each other in light receiving characteristics (light sensitivity characteristics). More specifically, the first CCD 30a is a high-sensitivity CCD having a large pixel size (the size of a light receiving area of the light-receiving element) and a low resolution, which is suitable for natural light capturing with relatively low illuminance. On the other hand, the second CCD 30b is a low-sensitivity CCD having a small pixel size and a high resolution, which is suitable for natural light capturing with relatively high illuminance.

Thus, the CCDs 30a and 30b are different from each other in the light sensitivity to the input light intensity and the acceptable range (dynamic range). In other words, the CCDs 30a and 30b correspond to those in Example 1 shown in FIG. 3. Moreover, the CCDs 30a and 30b may be different from each other in the light receiving characteristics such as the spectral sensitivity characteristics, the shapes and arrangement of the light-receiving areas of the light-receiving elements forming the respective CCDs, the arrangement of the color separation filters or the arrangement pitch or pixel number of the light-receiving element, depending on the capturing resolution.

On the other hand, the capturing optical systems 21a and 21b are formed by different types of zoom lenses, respectively. The zoom lenses can change the focal length and the magnification substantially continuously without changing the focus position. Moreover, the capturing optical systems 21a and 21b are different from each other in the wavelength transmittance in the natural light region. Thus, the capturing optical systems 21a and 21b correspond to those in Examples 1 and 4 shown in FIG. 4.

For example, the first capturing optical system 21a includes a capturing lens 22a having a zoom lens 220a and a focus lens 222a, a diaphragm 24a, a shutter 26a, a half mirror 27a and an optical LPF (low-pass filter) 28a, and is a bright lens having a large wavelength transmittance in the natural light region. The optical LPF 28a is used for preventing generation of a pseudo signal (or pseudo color signal) that may be generated by higher spatial frequency components than the spatial frequency of the arrangement pitch of the light-receiving elements forming the CCD 30a (pixel pitch) or the pitch of the color separation filters. Although not shown, the first capturing optical system 21a includes an IR cut filter (IR) for cutting infrared light, that has a high wavelength transmittance in a visible light region and a low wavelength transmittance in an infrared light region as an example of invisible light region, provided in the vicinity of the optical LPF 28a on the optical path.

Due to this structure, an image of the subject captured by the first capturing optical system 21a is formed on the light receiving surface of the first CCD 30a. In accordance with the light amount of the formed image of the subject, electric charges are stored in respective sensor elements (not shown) of the first CCD 30a (these electric charges are stored charges). The stored charges are read into a shift register (not shown) by read gate pulses and are then read as analog voltage signals successively by register transfer pulses. The analog voltage signals output from the first CCD 30a are input to the selection unit 31.

Since the digital camera 10 typically includes an electronic shutter function, a mechanical shutter such as the shutter 26a is not necessary. In order to realize the electronic shutter, a shutter drain is provided via a shutter gate in the first CCD 30a. When the shutter gate has been driven, the stored charges are drained out to the shutter drain. By controlling the shutter gate, a time for storing the electric charges in the respective sensor elements, i.e., the shutter speed can be controlled.

The second capturing optical system 21b includes a capturing lens 22b having a zoom lens 220b and a focus lens 222b, a diaphragm 24b, a shutter 26b, a half mirror 27b and an optical LPF 28b, like the first capturing optical system 21a. Although not shown, the second capturing optical system 21b includes an IR cut filter provided in the vicinity of the optical LPF 28b on the optical path, like the first capturing optical system 21a. Due to this structure, an image of the subject captured by the second capturing optical system 21b is formed on the light-receiving surface of the second CCD 30b and then analog voltage signals output from the second CCD 30b are input to the selection unit 31.

The capturing optical systems 21a and 21b respectively formed by the zoom lenses may have approximately the same focal length region, the focal length regions partially overlapped, or the focal length regions different from each other. It is preferable that two series of voltage signals output from the respective CCDs have been calibrated.

The selection unit 31 selects one of the capture signals acquired by the respective CCDs 30a and 30b in accordance with the instruction from the capturing system CPU 50 serving as the selection controller, so as to input the selected one of the capture signals to the capture signal processor 32.

The capture signal thus input is subjected to color separation into R, G and B components by the capture signal processor 32, and the white balance is then adjusted. Then, the capture signal processor 32 performs Gamma correction, A/D conversion for the respective R, G and B signals at necessary timings one after another, and outputs digital image data obtained by the above processes to the main bus 82 of the processing unit 60.

The image capturing unit 20 further includes the finder unit 34 having a finder 34a and the electronic flash 36. The finder unit 34 has an optical switch 350 and a mirror 352 which allows light that has passed through the optical switch 350 to be incident on the finder 34a. The optical switch 350 allows one of reference light L2a carrying a part of the subject image reflected by the half mirror 27a of the first capturing optical system 21a and reference light L2b carrying a part of the subject image reflected by the half mirror 27b of the second capturing optical system 21b to pass therethrough selectively. This selection is made in accordance with the instruction from the capturing system CPU 50 so as to be linked with the selection of the capture signal in the selection unit 31. For example, when the selection unit 31 selects the capture signal of the first CCD 30a, the optical switch 350 allows the reference light L2a reflected by the half mirror 27a of the first capturing optical system 21a to pass therethrough.

The optical switch 350 is realized by a combination of a movable mirror and/or a movable prism capable of changing the orientation(s) thereof in accordance with the instruction from the capturing system CPU 50 and a fixed mirror and/or a fixed prism, for example.

An LCD (not shown) may be incorporated into the finder unit 34. In this case, various kinds of information from the main CPU 62, described later, can be displayed within the finder unit 34. The electronic flash 37 operates by light emission caused when energy stored in a capacitor (not shown) is supplied to a discharge tube 36a.

An example of a main operation of the digital camera 10 having the aforementioned structure is described below. First, when a power switch 112 of the digital camera 10 has been turned on, a main power is turned on and electric power is supplied to the respective parts in the camera.

The main CPU 62 then determines whether or not the digital camera 10 is in a capture mode or a playback mode by reading the status of the function setting portion 116. In a case where the digital camera 10 is in the capture mode, the main CPU 62 monitors whether or not the release switch 114 is half-pressed. When the main CPU 62 acquired an instruction of half-pressing, the main CPU 62 determines that the user issued an instruction of preprocessing, that is one instruction of various capturing instructions, and then acquires the measured luminance data and the measured distance data from the luminance sensor 54 and the distance sensor 52, respectively. The capture controlling unit 40 then operates based on the acquired data, so that the focus of the capturing lens 22, the aperture size and the like are adjusted. Please note that the capturing system CPU 50 may make the adjustment for only one of a combination of the first capturing optical system 21a and the first CCD 30a and a combination of the second capturing optical system 21b and the second CCD 30b.

After the adjustment was finished, the main CPU 62 makes the LCD monitor 102 present the subject image on which characters “stand-by” are overlapped, thereby notifying the user that the digital camera 10 is in a “stand-by” state. Thus, the user can confirm not only that the digital camera 10 is in the “stand-by” mode but also the subject image which is not still.

Then, the main CPU 62 monitors whether or not the release switch 114 has been completely pressed. When acquiring an instruction of complete pressing of the release switch 114, the main CPU 62 determines that the user issued an instruction of an executive operation, that is one instruction of the various capturing instructions. Thus, the shutter is closed after a predetermined shutter time has passed, and then the stored charges in the CCD are drained out to the selection unit 31.

The selection unit 31 is controlled by the capturing system CPU 50 to select one of the capture signals acquired by the respective CCDs 30a and 30b, and then outputs the selected capture signal to the capture signal processor 32. The digital image data generated as a result of image processing by the capture signal processor 32 is output to the main bus 82. The digital image data is stored in the main memory 68 temporarily, and is then processed by the YC processor 70 and the compress/expand processor 78. The main CPU 62 serving as a storing controller of the present invention makes the image data after being processed be stored (recorded) in a predetermined storage region of the memory card 77 via the optional device controller 74. The main CPU 62 makes the LCD monitor 102 continue to present the recorded image for a while, while the image is frozen. In this case, the user can confirm the subject image after being captured. Thus, a sequence of the capturing operation has been finished.

On the other hand, in a case where the digital camera 10 is in the playback mode, the main CPU 62 reads out the last captured image from the main memory 68 via the memory controller 64 and makes the LCD monitor 102 of the display unit 100 present the thus read image. In this state, when the user sets “forward” or “backward” in the function setting portion 116, the main CPU 62 reads the images captured before or after the currently displayed image from the memory card 77 via the optional device controller 74, so as to make the LCD monitor 102 display the thus read images.

Then, the main CPU 62 reads the status of the function setting portion 116 and determines whether or not the digital camera 10 is in the capture mode or the replay mode. In a case where the digital camera 10 is in the capture mode, the main CPU 62 monitors whether or not the release switch 114 is half-pressed. When CPU 62 receives an instruction representing a half-pressing it recognizes that the user of camera issues a preprocessing instruction, which is one instruction of the various capturing instructions. Next, CPU 62 acquires the measured luminance data and the measured distance data from the luminance sensor 54 and the distance sensor 52, respectively. The capture controlling unit 40 then operates based on the acquired data so that the focus of the capturing lens 22, the aperture size and the like are adjusted. In this operation, the capturing system CPU 50 may take place the adjustment for only one of a combination of the first capturing optical system 21a and the first CCD 30a and a combination of the second capturing optical system 21b and the second CCD 30b.

After completing the adjustment, the main CPU 62 controls the LCD monitor 102 to display the subject image on which characters “stand-by” are superposed, thereby notifying the user that the digital camera 10 is in a “stand-by” state. Thus, the user confirms not only that the digital camera 10 is in the “stand-by” mode but also the subject image which is not still.

Subsequently, the main CPU 62 monitors whether or not the release switch 114 is completely pressed down. When main CPU 62 receives the instruction indicating a complete pressing of the release switch 114 it recognizes that the user instructs an executive operation which is one instruction of the various capturing instructions. Thus, the shutter is closed after a predetermined shutter time has passed and then the stored charges in the CCD are discharged out to the selection unit 31.

The selection unit 31 is controlled by the capturing system CPU 50 to select one of the capture signals acquired by the respective CCDs 30a and 30b, and then outputs the selected capture signal to the capture signal processor 32. The digital image data generated as a result of image processing by the capture signal processor 32 is output to the main bus 82. The digital image data is stored in the main memory 68 temporarily, and is then processed by the YC processor 70 and the compress/expand processor 78. The main CPU 62, serving as a storage controller according to the present invention, operates the image data after being processed to be stored or recorded in a predetermined storage region of the memory card 77 via the optional device controller 74. The main CPU 62 controls the LCD monitor 102 to continuously display the recorded image for a while, while the image is frozen. In this case, the user can confirm the subject image after being captured. Thus, a sequence of the capturing operation is finished.

The first capturing optical system 21a is a bright lens having a large wavelength transmittance in a natural light region, while the second capturing optical system 21b is a dark lens having a small wavelength transmittance in the natural light region. The first CCD 30a is a high-sensitivity CCD suitable for natural light capturing with relatively low illuminance, while the second CCD 30b is a low-sensitivity CCD suitable for capturing with high illuminance. Thus, based on the measured luminance data from the luminance sensor 54, the capturing system CPU 50 allows the combination of the first capturing optical system 21a and the first CCD 30a to be selected when the intensity of the light incident on the CCD serving as the capturing device is weaker than a predetermined intensity, and allows the combination of the second capturing optical system 21b and the second CCD 30b to be selected when the intensity of the incident light is stronger than the predetermined intensity. For example, by selecting the capture signal from the first CCD 30a in the capturing with relatively low illuminance and selecting the capture signal from the second CCD 30b in the capturing with relatively high illuminance, the dynamic range to the input light intensity can be substantially enlarged automatically, so that the applications of the digital camera 10 in which the image capturing can be performed are increased.

Moreover, it is possible to select the capture signal from the first CCD 30a when an image having an excellent S/N ratio is required and the capture signal from the second CCD 30b when a high-resolution image is required. Furthermore, the capturing device unit can be formed by appropriately selecting the light receiving characteristics such as spectral sensitivity characteristics, the shapes and arrangement of the light receiving areas of the light-receiving element forming the respective CCDs, the arrangement of the color separation filters, or the arrangement pitch or pixel number of the light-receiving element, depending on the difference between the capturing resolutions in the respective CCDs used.

For example, in a case where the focal length regions of the two zoom lenses 220a and 220b are set in such a manner that the regions are partially overlapped, the focal length of the first capturing optical system 21a is set shorter and that of the second capturing optical system 21b is set longer, as in Examples A and B shown in FIG. 5, the capturing system CPU 50 causes the first capturing optical system 21a to be selected when the distance to the subject is shorter than a predetermined distance and the second capturing optical system 21b to be selected when the distance to the subject is loner than the predetermined distance, based on the measured distance data from the distance sensor 52. Thus, by automatically switching one of the capture signals by the two zoom lenses 220a and 220b to the other based on the measured distance data and using it, the magnification range can be enlarged substantially continuously, thereby increasing the available applications in which the image capturing can be increased.

Moreover, in a case where the focal length regions do not overlap like Example C shown in FIG. 5, that is, in a case where the focal length regions of the respective zoom lenses have no overlapping portion, it can be switched which one of the wide-angle zoom lens and the telephoto lens is used depending on the capture condition. More specifically, the telephoto zoom lens is used when a distant view is to be captured while the wide-angle zoom lens is used when a near view is to be captured. Thus, the applications of the digital camera 10 in which the image capturing can be performed can be increased, and the amount of information that can be captured is also increased.

In addition, since the capture signal processor 32 and the storage medium can be commonly used, the number of parts can be reduced and the cost can be also reduced, as compared to a case where two series of capture signal processors are provided to respectively correspond to the different types of optical systems. Moreover, the calibration for two series of image data is much easier than the calibration for two separate digital cameras.

Furthermore, it becomes unnecessary for the user to carry two digital cameras 10 having optical systems of different types. Moreover, the digital camera 10 of the present embodiment is convenient because the capturing optical system and the capturing device are automatically switched based on the measured distance data and the measured luminance data.

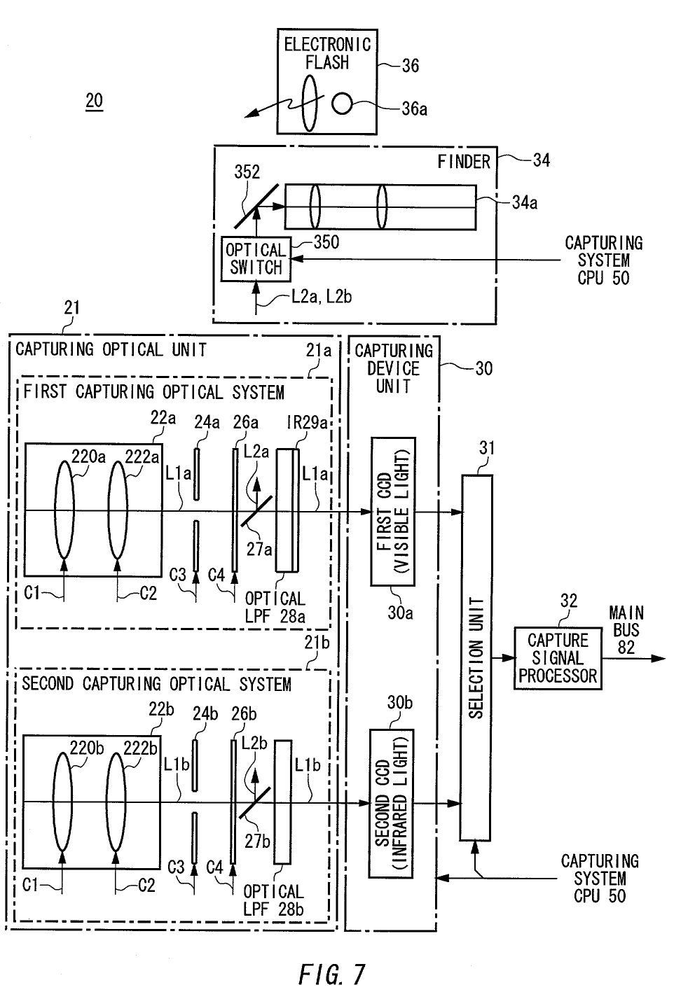

FIG. 7 shows details of the image capturing unit 20 of the digital camera 10 according to the second embodiment of the present invention. The capturing device unit 30 of the present embodiment is different from that of the first embodiment in that it includes CCDs having different spectral sensitivity characteristics from each other as different types of capturing characteristics. For example, the spectral sensitivity in the visible light region is higher in the fist CCD 30a than in the second CD 30b, while the spectral sensitivity in the infrared light region, that is an exemplary invisible light region, is higher in the second CCD 30b than in the first CCD 30a. That is, the CCDs 30a and 30b correspond to CCDs in Example 2 shown in FIG. 3, and the first CCD 30a is a device for color image capturing suitable for the image capturing with visible light while the second CCD 30b is a device for the image capturing with infrared light. The shapes and arrangement of the light receiving areas of the light-receiving elements and the arrangement pitch, pixel number, effective capturing area and reading method of the respective light-receiving element may be the same or different.

The capturing optical unit 21 is different from that of the first embodiment in that it includes the first capturing optical system 21a that has an IR cut filter 29a provided after the optical LPF 28a on the optical path and the second capturing optical system 21b that has no IP cut filter. Due to this structure, the first and second capturing optical systems 21a and 21b can have different wavelength transmittance characteristics. The first CCD 30a receives light L1a that passed through the first capturing optical system 21a and captures a visible light image, while the second CCD 30b receives light L1b that passed through the second capturing optical system 21b and captures an infrared light image that is an example of an invisible light image. In the above image capturing, the output level of the capture signal corresponding to the infrared light, that is output from the second CCD 30b, becomes larger because the second capturing optical system has no IR cut filter.

Thus, in the digital camera 10 of the present embodiment, the capturing system CPU 50 makes the combination of the first capturing optical system 21a and the first CCD 30a be selected in order to perform the visible light (natural light) capturing when the intensity of the incident light on the CCD serving as the capturing device is greater than a predetermined intensity, and also makes the combination of the second capturing optical system 21b and the second CCD 30b be selected in order to perform the infrared light capturing when the intensity of the incident light is greater than the predetermined intensity, based on the measured luminance data from the luminance sensor 54. In this manner, the user can use the digital camera 10 both for the visible light capturing and for the infrared light capturing, thereby increasing the applications in which the image capturing can be performed.

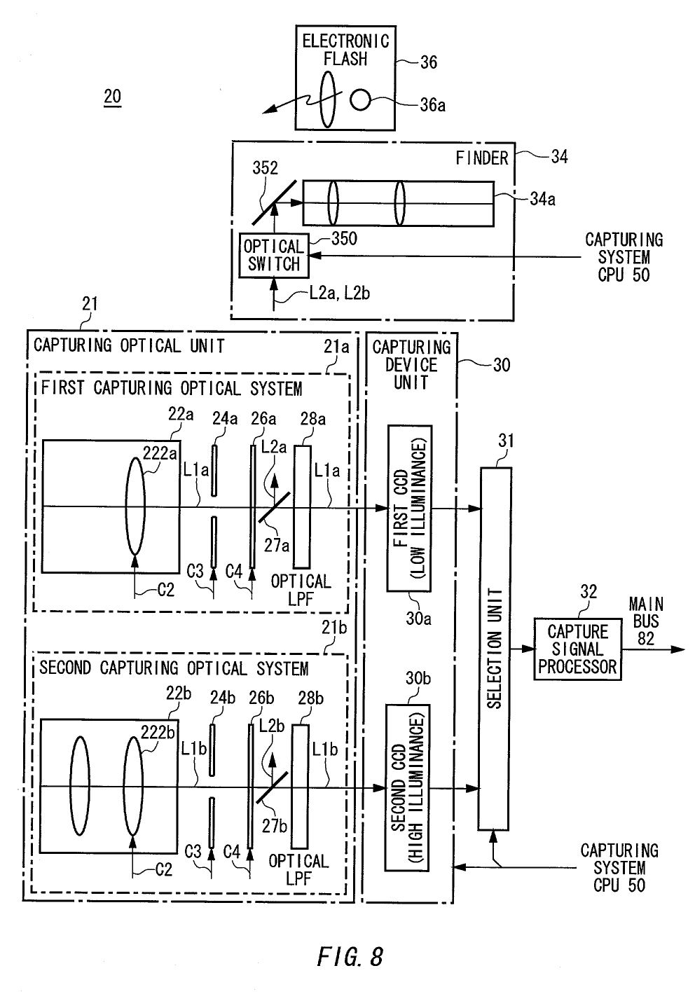

FIG. 8 shows details of the image capturing unit 20 of the digital camera 10 according to the third embodiment of the present invention. The capturing optical systems 21a and 21b of the capturing optical unit 21 are different from those of the first embodiment in that each of the capturing optical systems 21a and 21b is formed by a fixed-focus lens and includes no zoom lens and they have single focus lengths different from each other. That is, the capturing optical systems 21a and 21b correspond to those in Example 3 shown in FIG. 4.

In a case where the focal lengths f of the two fixed-focus lenses are different from each other and one is a wide-angle lens (for example, f=28 mm) while the other is a telephoto lens (for example, f=300 mm), it is possible to switch two capture signals respectively corresponding to the wide-angle lens and the telephoto lens, depending on the capture condition. For example, the capture signal corresponding to the telephoto lens is used in order to capture a distant view, whereas the capture signal corresponding to the wide-angle lens is used in order to capture a near view. Thus, also in the third embodiment, the application can be increased and the amount of information that can be captured is also increased.

Moreover, also in the digital camera 10 of the third embodiment, the same effects as those in the first embodiment can be obtained. For example, the dynamic range for the input light intensity can be substantially enlarged by switching the capture signals from the respective CCDs depending on the condition such as the illuminance. In addition, the number of parts and the cost can be reduced as compared to a case where two series of image processors having different optical characteristics are separately provided.

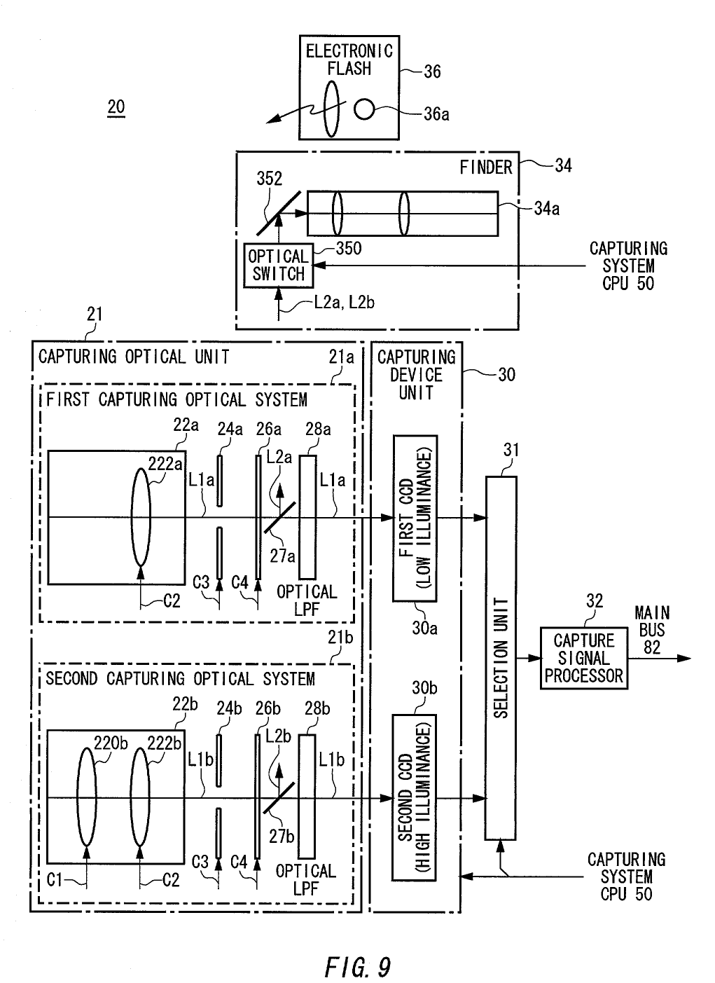

FIG. 9 shows details of the image capturing unit 20 of the digital camera 10 according to the fourth embodiment of the present invention. The first capturing optical system 21a of the capturing optical unit 21 is a fixed-focus lens having no zoom lens as in the third embodiment, while the second capturing optical system 21b is formed by the zoom lens 220b like the first embodiment. That is, the capturing optical systems 21a and 21b correspond to those in Example 2 shown in FIG. 4. For example, it is preferable that the focal length of the fixed-focus lens of the first capturing optical system 21a be out of the focal length region of the zoom lens 220b of the second capturing optical system 21b.

Moreover, also in the digital camera 10 of the fourth embodiment, the same effects as those in the first embodiment can be obtained. For example, the dynamic range for the input light intensity can be substantially enlarged by switching the capture signals from the respective CCDs depending on the condition such as the illuminance. In addition, the number of parts and the cost can be reduced as compared to a case where two series of image processors having different optical characteristics are separately provided.

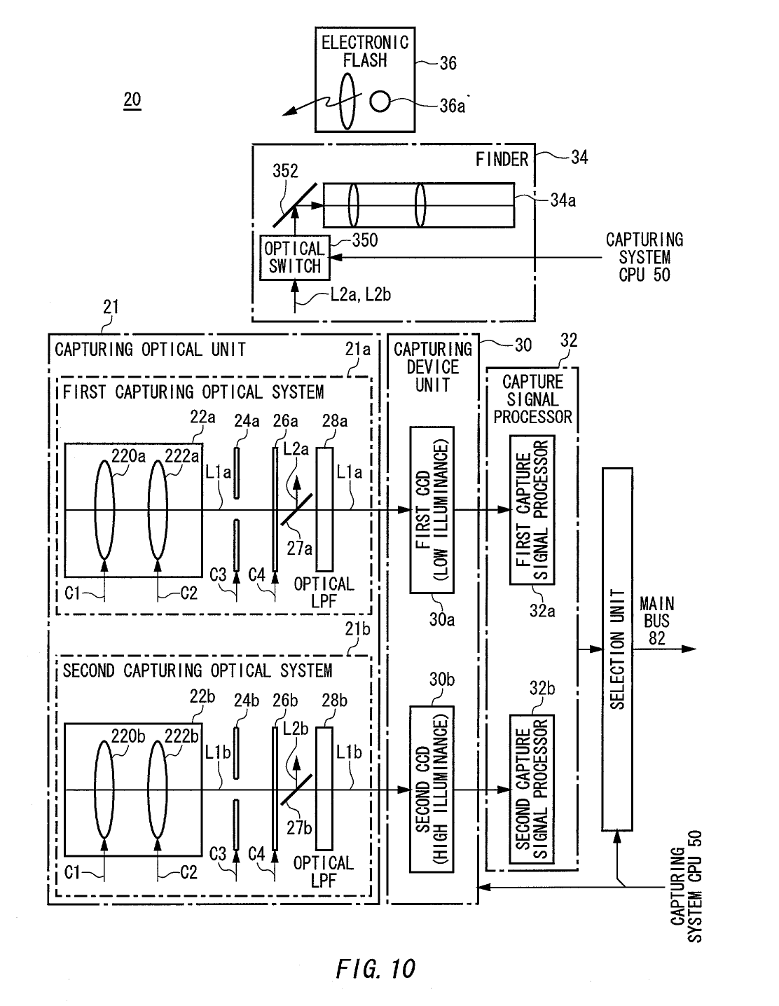

FIG. 10 shows details of the image capturing unit 20 of the digital camera 10 according to the fifth embodiment of the present invention. The image capturing unit 20 of the present embodiment is different from that of the first embodiment in the order in which the capture signal processor 32 and the selection unit 31 are arranged is changed. The capture signal processor 32 includes the first capture signal processor 32a which performs predetermined image processing for the capture signal from the first CCD 30a and the second capture signal processor 32b which performs predetermined image processing for the capture signal from the second CCD 30b. The first capture signal processor 32a and the second capture signal processor 32b perform different types of image processing for the corresponding capture signals output from the respective CCDs depending on the types of the capturing optical systems 21a and 21b or capturing devices 30a and 30b. The capture signals after being processed output from the capture signal processors 32a and 32b are input to the selection unit 31 provided after the capture signal processor 32.

The selection unit 31 is controlled by the capturing system CPU 50 so as to select one of the capture signals after being processed output from the respective capture signal processors 32a and 32b, and then outputs the selected capture signal to the main bus 82 of the processing unit 60.

Although the order of the capture signal processor 32 and the selection unit 31 is changed, the same effects as those in the first embodiment can be obtained in the above structure. Moreover, since the capture signal processor 32 has a plurality of separate capture signal processors, processors capable of performing the optimum image processing can be formed depending on combinations of the types of the capturing optical systems and capturing characteristics of the capturing devices, thus increasing the freedom of design.

Please note that the fifth embodiment can be applied not only to the first embodiment but also to any of the second, third and fourth embodiments, and the same effects can be obtained.

The number of the capturing optical systems or the capturing devices is not limited two. Three or more capturing optical systems or capturing devices may be provided. Moreover, the capturing device is not limited to the CCD (charge transferring device), but may be an XY addressing type device such as a C-MOS type. For example, the C-MOS type device is unfavorable in the resolution or S/N. However, in a case of the C-MOS type, an image capturing apparatus with a low power consumption can be realized at a reduced cost.

Moreover, without providing a half mirror for reflecting a part of the subject image captured by the respective capturing optical system, a finder through which the user can confirm a reference image may be provided for each capturing optical system in such a manner that the finder for one capturing optical system is separate from that for another capturing optical system. Since the structure of the finder is simple, the apparatus structure can be simplified because no structure for switching the reference light input to the finder so as to be linked with the switching of the capturing optical systems is included.

Although the image capturing apparatus of the present invention was described referring to the digital camera for capturing a still image as an example in the above embodiments, the image capturing apparatus of the present invention is not limited thereto. The image capturing apparatus of the present invention may be a video movie camera for capturing a movie, for example. Moreover, it is not necessary for the image capturing apparatus of the present invention to include a storing controller for making the captured image be stored in a memory or the like. In this case, the captured image is output to an external apparatus via a video output terminal, for example.

As described above, according to the present invention, the capturing optical systems and the capturing devices can be automatically switched to be used depending on the capture condition such as the distance to the subject or the illumination. Thus, the applications of the image capturing apparatus in which the image capturing can be performed can be increased.

Although the present invention has been described by way of exemplary embodiments, it should be understood that those skilled in the art might make many changes and substitutions without departing from the spirit and the scope of the present invention which is defined only by the appended claims.

What is claimed is:

1. An image capturing apparatus for capturing an image of a subject, comprising:
a capturing unit including a plurality of capturing optical systems and a plurality of capturing devices operable to receive light beams from said plurality of capturing optical systems to capture images of said subject, respectively, and output capture signals;
a capture condition acquiring unit operable to acquire information indicating a capture condition determined based on a positional relationship between said subject and said image capturing apparatus; and
a selection controller operable to control said capturing unit to select one of said plurality of capturing optical systems and/or one of said plurality of capturing devices in accordance with said capture condition acquired by said capture condition acquiring unit.

2. An image capturing apparatus as claimed in claim 1, wherein said plurality of capturing optical systems include a first capturing optical system having a shorter focal length and a second capturing optical system having a longer focal length,
said capture condition acquiring unit includes a distance measuring unit operable to acquire information indicating a distance between said subject and said image capturing apparatus, as said information indicating said capture condition, and
said selection controller controls said capturing unit to select said first capturing optical system when said distance between said subject and said image capturing apparatus is shorter than a predetermined distance or said second capturing optical system when said distance between said subject and said image capturing apparatus is longer than said predetermined distance.

3. An image capturing apparatus as claimed in claim 1, wherein said plurality of capturing optical systems include a first capturing optical system having a larger wavelength transmittance in a natural light region and a second capturing optical system having a smaller wavelength transmittance in said natural light region,
said capture condition acquiring unit includes a luminance measuring unit operable to acquire information indicating an intensity of incident light on the capturing apparatus determined depending on brightness of illumination for illuminating said subject, as said information indicating said capture condition, and
said selection controller controls said capturing unit to select said first capturing optical system when said intensity of said incident light is weaker than a predetermined intensity or said second capturing optical system when said intensity of said incident light is stronger than said predetermined intensity.

4. An image capturing apparatus as claimed in claim 1, wherein said plurality of capturing devices include a first capturing device having a higher light sensitivity in a natural light region and a second capturing device having a lower light sensitivity in said natural light region,
said capture condition acquiring unit includes a luminance measuring unit operable to acquire information indicating an intensity of light incident on the capturing apparatus determined depending on brightness of illumination for illuminating said subject, as said information indicating said capture condition, and
said selection controller controls said capturing unit to select said first capturing device when said intensity of said incident light is weaker than a predetermined intensity or said second capturing device when said intensity of said incident light is stronger than said predetermined intensity.

5. An image capturing apparatus as claimed in claim 4, wherein said plurality of optical systems include a first capturing optical system having a larger wavelength transmittance in said natural light region and a second capturing optical system having a smaller wavelength transmittance in said natural light region, and
said selection controller controls said capturing unit to select said first capturing optical system when said intensity of said incident light is weaker than said predetermined intensity or said second capturing optical system when said intensity of said incident light is stronger than said predetermined intensity.

6. An image capturing apparatus as claimed in claim 1, wherein said plurality of optical systems include a first capturing optical system having a smaller wavelength transmittance in an infrared light region and a second capturing optical system having a larger wavelength transmittance in said infrared light region,
said capture condition acquiring unit includes a luminance measuring unit operable to acquire information indicating an intensity of light incident on the capturing apparatus determined depending on brightness of illumination for illuminating said subject, as said information indicating said capture condition, and
said selection controller controls said capturing unit to select said first capturing optical system when said intensity of said incident light is stronger than a predetermined intensity or said second capturing optical system when said intensity of said incident light is weaker than said predetermined intensity.

7. An image capturing apparatus as claimed in claim 1, wherein said plurality of capturing devices include a first capturing device having a lower light sensitivity in an infrared light region and a second capturing device having a higher light sensitivity in said infrared light region,
said capture condition acquiring unit includes a luminance measuring unit operable to acquire information indicating an intensity of light incident on the capturing apparatus determined depending on brightness of illumination for illuminating said subject, as said information indicating said capture condition, and
said selection controller controls said capturing unit to select said first capturing device when said intensity of said incident light is stronger than a predetermined intensity or said second capturing device when said intensity of said incident light is weaker than said predetermined intensity.

8. An image capturing apparatus as claimed in claim 7, wherein said plurality of optical systems include a first capturing optical system having a smaller wavelength transmittance in said infrared light region and a second capturing optical system having a larger wavelength transmittance in said infrared light region, and
said selection controller controls said capturing unit to select said first capturing optical system when said intensity of said incident light is stronger than said predetermined intensity or said second capturing optical system when said intensity of said incident light is weaker than said predetermined intensity.
